(19) United States
(12) Patent Application Publication
(10) Pub. No.: US 2007/0246153 A1
(43) Pub. Date: Oct. 25, 2007

(54) Dispenser for self-sticking tape and method of use

(76) Inventor: David B. Schurman, Albany, NH (US)

Correspondence Address: Michael J. Perrson;Lawson & Persson, P.C., Suite 103, 67 Water Street, Laconia, NH, 03246, US

(21) Appl. No.: 11/729,910

(22) Filed: Mar. 29, 2007

Related U.S. Application Data
(60) Provisional application No. 60/790,734, filed on Apr. 10, 2006.

(51) Int. Cl. B29C 53/78; B32B 37/12; B44C 7/00; B29C 69/00; B65H 35/07

(52) U.S. Cl. 156/185; 156/577; 156/195; 156/193; 225/38; 225/46; 225/51; 225/66; 242/423.2; 242/588.6

(57) ABSTRACT

A dispenser for applying tape from a roll of tape including a pair of side supports, a means for rotatably suspending the roll of tape between the side supports, and a means for applying a variable force upon the roll of tape to resist rotation of the roll of tape such that the tape may being stretched when it is wound about the object.

### CLAIM OF PRIORITY

This application claims the benefit of priority of U.S. Provisional Patent Application Ser. No. 60/790,734, filed on Apr. 10, 2006.

### BACKGROUND OF THE INVENTION

Electrical tape can be used to form a strong, weather-tight covering to protect objects from getting wet, corroding or suffering physical damage. It can also be used in such a way as to form a strong strain relief for wires and cords where they exit from equipment and appliances. Electrical tape will also form a strong bond between objects that are taped together such as 2 wires or a wire or cable to a fish tape for pulling the wire or cable through a restricted space or conduit.

In order for the electrical tape to form a strong water-tight bond it must be wrapped tightly into place so that no gaps occur between the layers of tape. This is facilitated by stretching the tape as it is applied. If a good quality electrical tape is used, it can be stretched tightly as it is wrapped onto the item being protected and it will form a strong, tight covering that will provide excellent protection.

It can be difficult to apply electrical tape properly. As the tape is wrapped around a wire, connector or other object, one must let go of the roll as it passes behind the object and then grab it from the other side to continue the wrap. This letting go and re-grabbing must take place with each wrap of the tape. When the tape is let go, the stretch that is applied to the tape is relaxed and it must be restretched each time it is re-grabbed. This stretching process can be tiresome and it can cause aching in the hands and wrists. Many people have difficulty getting a good, tight wrap.

In addition to the fatigue caused by manually stretching electrical tape, it is likewise difficult to maintain the proper and consistent degree of tension on the tape. Too little tension results in inadequate stretching and a poor bond, while too much tension can cause the tape to break and cause more fragile wire connections to be severed. Further, in cases where small wires, such as microphone wires, are to be taped, it is almost impossible to manually stretch the tape sufficiently to create a seal around the wires.

Once electrical tape is manually stretched and wrapped, the installer must either break the tape manually or take a separate knife to cut it. Manual breaking of the tape results in uneven ends and can overstretch the portion of the tape proximate to the break, causing it to lose its strength. Conversely, the use of a separate knife requires the installer to remove both hands from the wires being wrapped, which may result in the wires moving and needing to be repositioned.

The above problems may be overcome by using other methods of sealing wires and cables. For example, mastic impregnated tape will create a watertight seal without stretching. However, this tape is expensive, is extremely messy to install and leaves a sticky residue on the wires that is difficult to remove if the tape ever needs to be removed. Shrink tube products may be used to seal wires in some applications. However, these tubes are also expensive, they require a source of heat to cause them to shrink and create the necessary seal, and are impractical when large areas need to be sealed.

Therefore, there is a need for a device that will automatically hold a tension on electrical tape as it is wrapped into place to form a tight covering, that reduces the fatigue caused by manually stretching electrical tape, that allows the tension on the tape to be adjusted to fit the requirements of different situations, that provides a means of supporting small wires and objects so that they can be wrapped tightly with tape to produce a watertight seal, that provides an integral blade for cutting the tape when the wrapping is complete, that allows for the dispensing and cutting off lengths of tape as needed, and that allows wires to be inexpensively sealed without the use of mastic tape or shrink tubes.

### SUMMARY OF THE INVENTION

The present invention is a dispenser for dispensing self-sticking tape and a method of using the dispenser. In its most basic form, the dispenser for applying tape from a roll of tape includes a pair of side supports, a means for rotatably suspending the roll of tape between the side supports, and a means for applying a variable force upon the roll of tape to resist rotation of the roll of tape such that the tape may be stretched when it is wound about the object. The sides supports are manufactured of a substantially resilient material and are attached together a substantially fixed distance apart. The side supports each include an extending arm dimensioned to support an object to be taped in such a way that the object is held in a substantially fixed relationship to a center of the roll of tape as the roll of tape is caused to pivot around the object to be taped. The side supports each also include an opening therethrough disposed at a location such that an axis defined by a centerpoint of the opening in each side support is substantially perpendicular to each side support.

In the preferred embodiment, the means for rotatably suspending the roll of tape between the side supports and the means for applying a variable force upon the roll of tape are a single means for both rotatably suspending the roll of tape between the side supports and for applying a variable force upon the roll of tape, which preferably takes the form of a friction drag system. The preferred friction drag system includes a substantially hollow shaft, at least one fastener and a pair of hub spacers. The shaft is dimensioned for insertion within the openings in the side supports and the fastener having a diameter dimensioned for insertion within the hollow shaft. The hub spacers each include a cylindrical projection dimensioned for insertion within an opening in the roll of tape, a flange portion having an outer surface and an inner surface dimensioned to contact a side of the roll of tape and prevent further insertion of the hub spacers within the opening of the roll of tape when an inward force is applied thereto, and a central opening dimensioned to accept the hollow shaft. To assemble the friction drag system and tape to the supports, the cylindrical projections of the hub spacers are disposed in opposite sides of the opening in the roll of tape such that the flange portion of each hub spacer contacts the roll of tape, the roll of tape and hub spacers are inserted between the side supports such that the openings in the side supports align with the central openings in the hub spacers, the shaft is inserted through the openings in the side supports and the central openings in the hub spacers, and the at least one fastener is inserted within the hollow shaft, secured, and tightened against the side supports so as to create an inward force upon the side supports.

In the preferred embodiment, the hollow shaft has a plurality of internal threads and the fastener is a pair of thumbscrews having external threads dimensioned to mate with the internal threads of the hollow shaft. It is likewise preferred that the side supports each include a substantially planar inner surface and that the flange portion of each of the hub spacers has a thickness dimensioned to allow the outer surface of the flange portion to be proximate to an inner surface of an adjacent side support when the roll of tape and hub spacers are inserted between the side supports. The flange portion of each of the hub spacers also preferably has a diameter that is at least 150% of the diameter of the opening in the roll of tape.

The preferred dispenser includes a cutting blade attached between the side supports. It is preferred that the extension arm of each side support has a groove within the inside surface thereof and wherein the cutting blade is disposed within both grooves.

The preferred dispenser also includes means for supporting an object that is insufficiently rigid to resist a tension caused by winding the tape over the object. This means for supporting an object that is insufficiently rigid to resist a tension caused by unwinding the tape over the object preferably takes the form of at least one, and preferably two free spinning roller secured between the side supports. In the preferred embodiment, each roller has a substantially equal diameter and wherein one of the rollers are disposed proximate to the other of the rollers.

When using a dispenser in accordance with the basic embodiment of the invention, the method of the present invention includes the steps of suspending the tape between the side supports, pulling a portion of the tape from the roll, attaching the tape to the object, supporting the object to be taped, applying a force that resists a rotation of the roll of tape within the side supports such that the tape is stretched from the roll of tape when the dispenser is rotated, rotating the dispenser about the object until the object is sufficiently covered with tape, and cutting the tape.

When using a dispenser in accordance with the preferred embodiment of the invention, the method of the present invention includes the steps of disposing the cylindrical projections in opposite sides of the opening in the roll of tape such that the flange portion of each hub spacer contacts the roll of tape, inserting the roll of tape and hub spacers between the side supports such that the openings in the side supports align with the central openings in the hub spacers, inserting the shaft through the openings in the side supports and the central openings in the hub spacers, inserting the at least one fastener within the hollow shaft, securing the fastener within the hollow shaft, pulling a portion of the tape from the roll, attaching the tape to the object, tightening the fastener against the side supports so as to create an inward force upon the side supports that resists a rotation of the roll of tape within the side supports such that the tape is stretched from the roll of tape when the dispenser is rotated, supporting an object to be taped, rotating the dispenser about the object until the object is sufficiently covered with tape, and cutting the tape.

Therefore, it is an aspect of the invention to provide a dispenser for self-sticking tape that will automatically hold a tension on electrical tape as it is wrapped into place to form a tight covering.

It is a further aspect of the invention to provide a dispenser for self-sticking tape that allows tension on the tape to be adjusted to meet the requirements of different situations.

It is a further aspect of the invention to provide a dispenser for self-sticking tape that includes a blade for cutting the tape when the wrapping is complete.

It is a further aspect of the invention to provide a dispenser for self-sticking tape that allows tape to be dispensed and cut off at various lengths as needed.

It is a further aspect of the invention to provide a dispenser for self-sticking tape that includes a means of supporting small wires and objects so that they can be wrapped tightly with tape to produce a watertight seal.

It is a still further aspect of the invention to provide a dispenser for self-sticking tape that allows wires to be inexpensively sealed without the use of mastic tape or shrink tubes.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a perspective right-side view of the preferred tape dispenser constructed in accordance with the invention.

FIG. 2 is a right-side view of the dispenser of FIG. 1 with the right side support cut away to show the working mechanism under normal operation

FIG. 3 is an exploded lateral cross-sectional view of the side supports and friction drag system of the preferred tape dispenser.

FIG. 4 is a right-side view of the preferred dispenser with the right side support cut away to show the working mechanism while taping small objects.

FIG. 5 is a cut way front view of the preferred roller.

FIG. 6 is an exploded front cross-sectional view of the side supports and friction drag system of an alternative embodiment of the tape dispenser in which an O-ring is added to create additional friction.

FIG. 7 is a cut away front view of an alternative embodiment of the tape dispenser in which a compressible rubber hub replaces the hub spacers of the preferred embodiment.

FIG. 8 is a front cross-sectional view of the preferred embodiment of the kit of the present invention in which two dispensers are joined together.

### DETAILED DESCRIPTION OF THE INVENTION

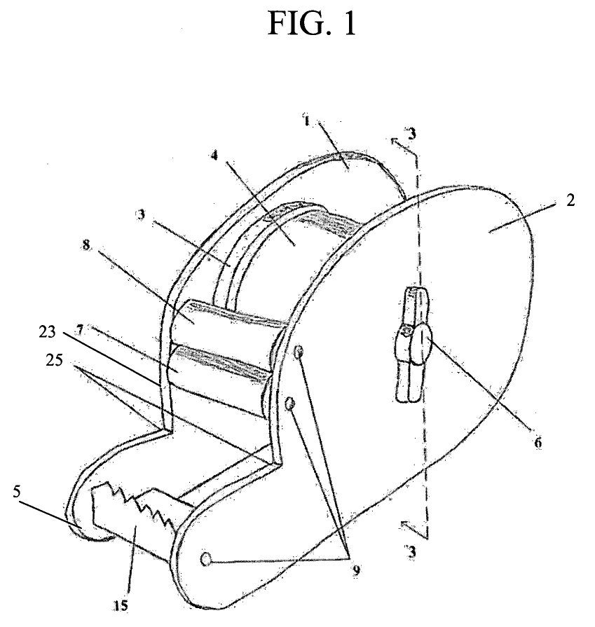

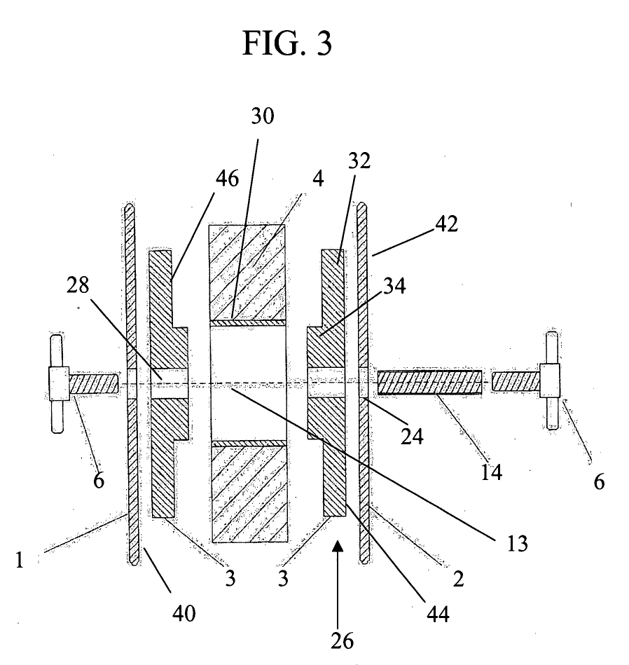

The preferred embodiment of the dispenser 20 is illustrated in FIGS. 1-4. The dispenser 20 has side supports 1 and 2, that are preferably flat and of uniform cross section, that make up the frame for the dispenser 20 and support all of the other parts. The side supports 1, 2 each have an inner surface 40, and outer surface 42 and an extending arm 5 that extends in a substantially perpendicular direction from the body 23 of the side supports 1, 2 to form a notch 25. This notch 25 provides a means of supporting an object 10 to be taped in such a way that the object 10 is held in a fixed relationship to the center of the roll of tape 4 as the roll of tape 4 is caused to pivot around the object 10. In the preferred embodiment, the extending arms 5 of the side supports terminate in rounded ends in order to avoid having sharp edges upon which the tape 4 could be caught. However, this is not required and other embodiments include side supports 1, 2 having extending arms 5 that are shaped to form a rectangle, triangle, trapezoid, rhombus or other shape.

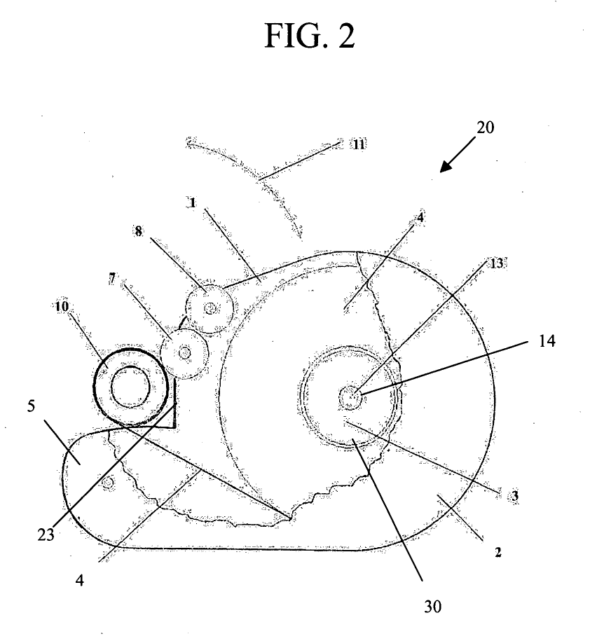

The preferred side supports 1, 2 each have an opening 24 therethrough at substantially the same location such that, when side supports 1, 2 are aligned, the openings 24 having center point that defines an axis 13 therethrough that is substantially perpendicular to each support 1, 2. As shown in FIGS. 2, 3 and 4, this axis 13 defines the axis formed through the center of the roll of tape 4.

The preferred supports 1, 2 are manufactured of a resilient material, such as ABS plastic, that will flex slightly when a force is applied thereto and bounce back to its original shape when the force is removed. The preferred supports 1, 2 are joined together at the end proximate the extending arm 5 via screws, pins, rivets, that secure the supports 1, 2 a fixed distance apart such that the inner surface 40 of each side support 1, 2 is in substantially parallel relation to other. It is preferred that the tape 4 be a roll of standard electrical tape having a width of three quarters of one inch (0.75 in.) and that the distance between the supports 1, 2 be approximately 1.1 inches. However, the dispenser 20 may be adapted to accept rolls of tape 4 having other widths, in which case the distance will vary such that it is slightly wider than the roll of tape 4 being used. In the preferred embodiment, the means for joining the supports 1, 2 are integrated into the means for securing the rollers 7, 8 and the cutting blade 15. However, separate means are employed in other embodiments. Further, in other embodiments, separate joining means are not utilized and the side supports are formed and attached together during the molding or forming process.

A roll of tape 4 is suspended between the two side supports 1 and 2 in such a way that it can revolve about axis 13 and such that a variable force may be applied thereupon to resist rotation of the tape 4, resulting in the tape being stretched when it is wound about an object 10. In the preferred embodiment, this is accomplished using a friction drag system 26 made up of hollow shaft 14, a pair of thumbscrews 6, and a pair of hub spacers 3 that act in concert with the side supports 1, 2 to resist the rotation of the tape. However, it is recognized that other art recognized means for resisting the rotation of the tape 4 may also be used to achieve similar results. For example, spring and pawl systems or disc drag systems similar to those utilized in connection with fly-fishing reels may be used. Similarly, friction wheel systems in which a spring-loaded wheel contacts the diameter of the roll of tape 4, or pad and caliper systems similar to conventional disc brake systems may be used. Accordingly, the invention should not be seen as being limited to the embodiments shown and described in detail herein.

In the preferred friction drag system 2, the hollow shaft 14 is dimensioned to fit within the openings 24 in the supports 1, 2, and extends between and holds two hub spacers 3, one on each side of the roll of tape 4. The shaft 14 is preferably manufactured of a lightweight metal, such as aluminum, and includes internal threads (not shown) that are dimensioned to mate with external threads of the thumbscrews 6. However, in other embodiments, the shaft 14 is merely a metal or plastic bushing having a smooth bore therethrough that is dimensioned to accept a bolt. In others, the shaft 14 is replaced by a pair of short flanged bushings, which are inserted though the openings 24 in the supports 1, 2 and extend a short distance therein to support the hub spacers. In still others, the shaft 14 is eliminated and is not replaced with a bushing, and the thumbscrew 6 are replaced by a carriage type bolt fastener having a central portion with a smooth surface about which the hub spacers 3 are rotatably disposed. Regardless of whether a shaft 14, bushing, or carriage type bolt is used, the function of these elements is to provide a surface about which the hub supports 3 may bear upon and freely rotate.

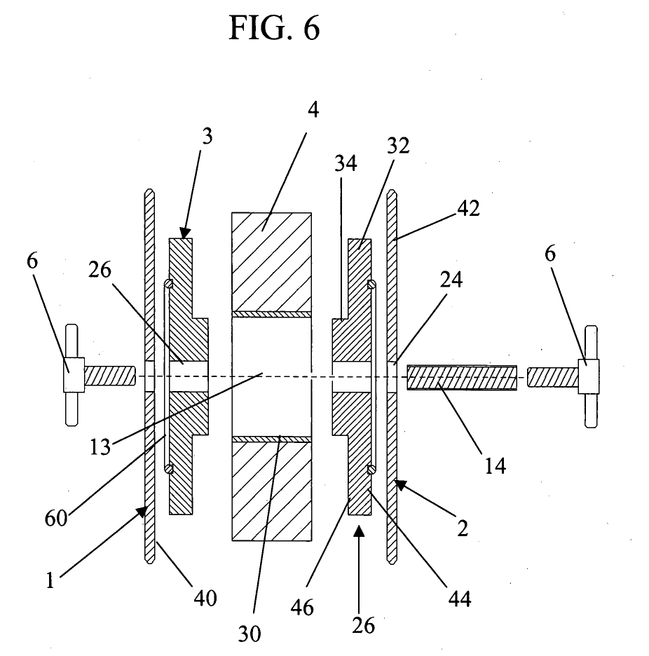

The hub spacers 3 each include openings 28 therethrough that are sized to accept the shaft 14 and provide sufficient clearance to allow the hub spacers 3 to rotate around the shaft 14 while maintaining the hub spacers 3 in substantially parallel relations to the supports 1, 2. The preferred hub spacers 3 each include a flange portion 32 and a cylindrical projection 34 that fits into the hole 30 in the center of the roll of tape 4. The flange portion 32 includes an outer surface 44 and an inner surface 46 and is preferably dimensioned such that its thickness allows the outer surface 44 to be proximate to the support 1, 2 when the thumbscrews 6 are not tightened. For purposes of the invention, the term “proximate to” means a distance of between 0.000 inches and 0.050 inches apart and, in this context means that the outer surface of the hub spacer 3 is between 0.000 inches and 0.050 inches from the inside surface 40 of the side support 1, 2. It is also noted that the hub spacers 3 may be sized to contact the side supports 1, 2 and slightly flex the side supports 1, 2 apart. Further, as described in detail in connection with FIG. 6, the hub spacers 3 may include an O-ring 60 or other friction-enhancing member extending therefrom and contacting the side supports 1, 2. In still other embodiments, the flange portion 32 is a thin disc on the inside surfaces of the side supports 1, 2 are built up such that they are directly proximate to, or lightly contact, the hub spacer 3 when the thumbscrews 6 are not tightened.

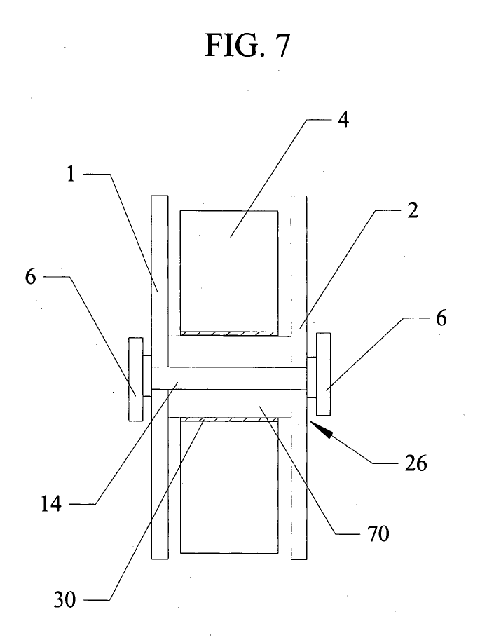

The flange portion 32 of the hub spacer 3 is also preferably dimensioned such that its outer diameter is sufficient to overlap a significant portion of the roll of tape 4 and preferably has a diameter that is at least one hundred and fifty percent (150%) of the diameter of the opening 30 in the roll of tape 4. This arrangement is preferred as it prevents misalignment of the roll of tape 4, provides a larger engagement surface between the hub spacer 1, 2 and the roll of tape 4 to prevent slippage between the roll of tape 4 and the hub spacers 3, and provides a larger contact area between the hub spacers 3 and the side supports 1, 2 to better distribute the forces upon the hub spacer. However, in other embodiments, the diameter of the flange portion 32 is reduced to a diameter slightly larger than the diameter of the cylindrical projections so as to prevent further insertion of the hub spacers 3 within the roll of tape 4 when an inward force is applied thereto. In still other embodiments, such as the embodiment of FIG. 7 the hub spacer 3 is manufactured of a compressible rubber material and the flange portion 32 is eliminated altogether.

The thumbscrews 6 screw into the shaft 14 and are dimensioned to exert an inward force on the supports 1, 2 when they are tightened so as to cause the two side supports 1 and 2 to flex inwardly to contact the two hub spacers 3 and the roll of tape 4 in a manner similar to an automobile clutch. The contact between the side supports 1, 2 and hub spacers 3 causes friction that resists the rotation of the roll of tape 4 around the axis 13 and places the tape 4 in tension when it is applied. Tightening and loosening the thumbscrews 6 varies the amount of frictional force applied upon the hub support 3 and allows the tension on the tape 4 to be adjusted to suit a particular taping job.

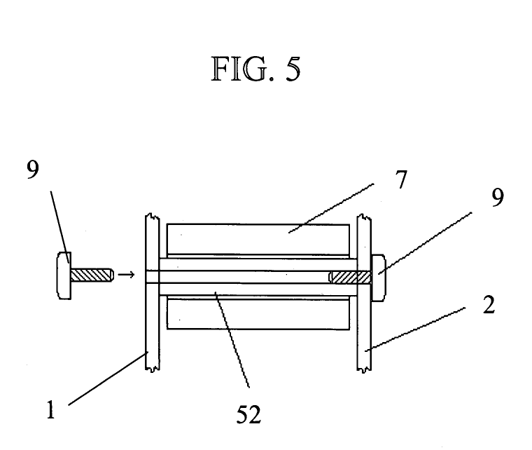

The preferred embodiment of the invention includes a means of supporting objects 10, such as thin wires, that are insufficiently rigid to resist the tension caused by winding the tape 4 over the area that is receiving the tape 4. In the embodiments shown in FIGS. 1, 2, and 4, this means takes the form of a pair of free spinning rollers 7 and 8, which are provided to allow for a smooth movement as the dispenser 20 is caused to pivot around the object 10 being wrapped. The two rollers 7 and 8 are supported on shafts 52 that are fastened between the two side supports 1 and 2. As shown in FIG. 5, this shaft 52 is preferably permanently secured using drive screws 9. However other fastening means, such as removable screws, pins, rivets or the like may also be used. In the preferred embodiment, the rollers 7, 8 are of substantially equal diameter and are manufactured of a relatively hard material, such as nylon, metal or hard plastic, having a substantially smooth outer surface.

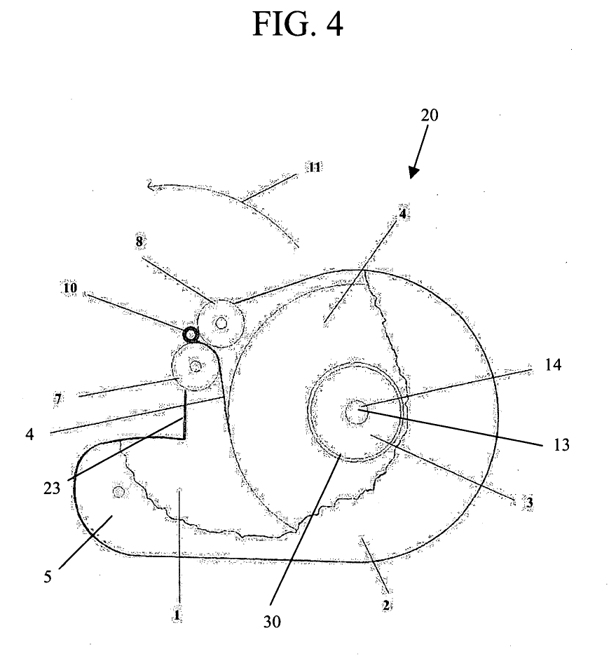

As shown in FIG. 2, a larger object 10 may be disposed between the extending arm 5 and roller 7, which rotates about the object 10 as the dispenser 20 is rotated. This rotation reduces the friction on the object 10 and makes rotation substantially easier. In such embodiments, frictional forces on the object may be further reduced by disposing another roller between the extending arms 5. In such an embodiment, the additional roller will extend slightly above the surface of the extending arm and is preferably movable such that it may be positioned to allow rotation of the object 10 without binding. Similarly, a FIG. 4 shows the dispenser 20 used with a smaller object 10, which is disposed between roller 7 and roller 8, each of which rotate about the object 10 when the dispenser 20 is rotated. The use of dual rollers 7, 8 provides significant advantages, as it allows a small object 10 to be cradled therebetween while being taped. In such embodiments, it is preferred that the tape 4 be fed between the rollers 7, 8 and around the object 10.

The preferred embodiment of the dispenser 20 also includes a cutting blade 15. In the embodiments of FIG. 1, the cutting blade 15 is an “L” shaped cutting blade 15, which is preferably affixed between the two side supports 1, 2 by setting the sides of the blade into “L” shaped groves (not shown) in the side supports 1, 2. A shaft is fastened between the side supports 1, 2, just behind the front of the cutting blade 15 to hold the side supports 1, 2 together keeping the sides of the blade 15 in the “L” shaped groves. However, in other embodiments the cutting blade 15 is mounted such that the cutting portion of the blade faces downward. In other embodiments, the cutting blade 15 is formed integral to the side supports 1, 2, similar to the blades on conventional rolls of transparent tape. In still other embodiments, the blade 15 is eliminated completely.

In operation, some tape 4 is pulled from the dispenser 20 and started onto the object that is to be taped. The thumbscrews 6 on the sides of the dispenser 20 are adjusted for the proper tension on the tape 4. When properly tensioned, the tape 4 will be stretched such that the width of the tape 4 will be reduced to between about fifty percent (50%) and seventy-five percent (75%) of its unstretched width. The dispenser 20 is pivoted up and around the object 10, which causes the tape 4 to be wrapped onto the object. With each revolution the dispenser 20 is moved along the axis of the object until the tape contacts the side support 1, 2. When using the dispenser of the preferred embodiment, this travel will be approximately one quarter of an inch (0.25 in.). However, it may be larger or smaller in other embodiments. The dispenser 20 is then moved in one direction until the object 10 is fully taped in this direction, moved back in the other direction to put a second covering of tape 4 over the object 10, and is moved back and forth as many times as are needed to provide an adequate covering of tape 4. The dispenser 20 is then pulled up so that the blade 15 engages the tape 4 and cuts it off.

In the embodiment of FIG. 2, the tape 4 is loaded into the dispenser 20 such that it may be fed from the bottom of the roll so that the sticky side is facing up and such that the object 10 that is being taped accepts the tape 4 from the bottom side. In operation, the object 10 that is being taped is held stationary and the dispenser 20 is caused to pivot up and over 11 the object 10 so that the tape 4 is wrapped around the object. The object 10 that is being taped pulls the tape 4 from the roll because it's position is held fixed in it's relationship to the roll of tape 4, by it location on the extending arm 5. Because the thumbscrew 6 is applying pressure that is resisting the rotation of the roll of tape 4 and the stickiness of the tape itself is resisting the unrolling of the tape 4 from tape roll, a tension is placed on the tape that causes it to stretch as it is wrapped around the object 10 that is being taped. It is this stretching that causes the tape 4 to form a tight jacket around the object 10 that is being taped. Further, because the hub spacers 3 include flange portions 32 that extend between the roll of tape 4 and the side supports, the dispenser 20 may be moved incrementally along the axis of the object 10 that is being taped without allowing the tape 4 to impinge against the side of supports 1 and 2. This allows for the distribution of the tape 4 over the entire area that needs to be covered by the tape 4 and as many layers as are needed can be applied. When the object 10 that is being taped has been adequately covered, the tape 4 is cut off by pulling up on the dispenser 20 so that the cut off blade 15 engages the tape 4 and cuts it off.

A further advantage of this device is it's usefulness in taping small wires and objects that are hard to support while taping because they are not rigid enough to resist the pull of the tape 4, while the tape 4 is being stretched. This process is illustrated in FIG. 4. In this embodiment, the tape 4 is fed between the two rollers 7 and 8 and started on the object being taped 10. When the device is caused to pivot 11 around the object being taped 10, the object 10 is supported by the two rollers 7, 8, over the area that is receiving the tape 4, as it is held in a fixed relationship to the roll of tape 4, allowing the tape 12 to be stretched as it is applied. Because the dispenser 20 of the present invention can automatically stretch the tape 4 as it is applied, it allows the user to get a tight protective cover that is otherwise difficult to achieve. The use of two rollers 7, 8 to support small items allows for a quality wrap of tape on objects that would otherwise be almost impossible to tape.

Referring now to FIG. 6, an alternative embodiment of the dispenser 20 is shown. This embodiment utilizes a friction drag system 26 that is similar in all respects to the friction drag system 26 of the preferred embodiment, except that an O-ring 60 is utilized to enhance the frictional characteristics of the dispenser 20. As shown in FIG. 6, the O-ring 60 is disposed within a groove cut within the outside surface 44 of the hub spacer 3. This O-ring 60 is preferably manufactured of a compressible material that will create a consistent amount of frictional force at a given inward pressure, which eliminates the variability that may occur based upon differences in the surface finishes of the outside surfaces of the hub spacers 3. O-rings 60 are also useful as they may be replaced when they wear out, whereas the hub spacers 3 may be worn smooth after excessive use, which can degrade their performance.

Although FIG. 6 shows an O-ring 60 disposed within a groove in the hub spacer 3, it is recognized that an O-ring could be mounted within a groove in the inside surface 40 of the side supports 1, 2. Similarly, the O-rings 60 may be replaced by flat rubber washers in other embodiments. In still other embodiments, the O-rings 60 are replaced by a series of compressible pads that are circumferentially mounted into openings in outer surface 44 of the hub spacers 3 or the inner surface 40 of the side supports. These pads may take many forms, but each serves the same purpose as the O-rings 60 of the embodiments of FIG. 6.

Referring now to FIG. 7, the friction drag system 26 may also take the form of a compressible hub 70 that extends through the opening 30 in the roll of tape 4 and contacts the side supports 1, 2. In such embodiments, a single compressible hub 70 replaces the hub spacers 3 of the preferred embodiment. The compressible hub 70 includes an opening therethrough that is sized to accept a hollow sleeve 14, or fastener. The compressible hub 70 is preferably manufactured of a material such as natural rubber, which will expand radially when compressed axially to hold the roll of tape 4 in place and likewise contact the side supports 1, 2 and sleeve 14 to generate a frictional force that resists rotation of the roll of tape 4.

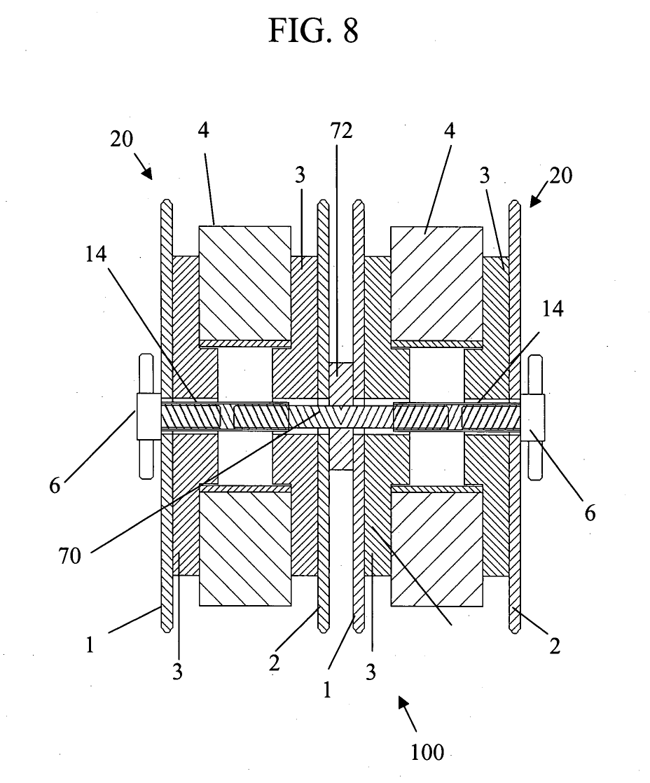

Referring now to FIG. 8, the preferred kit 100 of the present invention includes two or more dispensers 20 joined together. In the embodiment of FIG. 8, each dispenser 20 includes two side supports 1, 2, two hub spacers 3, a hollow sleeve 14 and a thumbscrew 6, which are arranged in a manner similar in all respects to the preferred embodiment of FIGS. 1-4. However, the second thumbscrew of FIGS. 1-4 is replaced by a threaded rod 70 which engages the threaded interior of each of the hollow sleeves 14 opposite the thumbscrews 6. The threaded rod 70 passes through a hollow bushing 72, which contacts the side support 1 of one dispenser 20 and side support 2 of the adjacent dispenser 20. In operation, the dispensers 20 are rotated such that their extending arms (not shown) are aligned and the thumbscrews 6 on each dispenser 20 are tightened such that the thumbscrews 6 exert an inward force upon the side supports 1, 2. This force sandwiches the dispensers 20 together against the bushing 72 and creates a frictional forces upon the hub spacers 3 that resists rotation of both dispensers 20. An object (not shown) is then disposed upon the extending arms (not shown) or between the rollers (not shown) and tape 4 is applied simultaneously by both dispensers 20. This is advantageous as it allows tape 4 to be dispensed twice as quickly as with a single dispenser.

Although the kit 100 of FIG. 8 shows two of the preferred dispensers 20 joined together, any of the embodiments of the dispenser 20 of the present invention may be adapted for use with the kit. Further, although two dispensers 20 are joined together in the preferred kit 100, other embodiments include three or more dispensers 20 joined together. In these embodiments, the hollow sleeves 14 are preferably unthreaded, a bushing 72 is provided between each dispenser 20 and the thumbscrews 6 are replaced by a carriage bolt (not shown) that is sized to extend between the assembled dispensers 20, and a nut (not shown) dimensioned to mate with the carriage bolt. Accordingly, the kit 100 of the present invention should not be seen as being limited to the embodiment shown in FIG. 8.

As is evident from the foregoing, the present invention has many uses. For example, it may be used to repair vacuum cleaner hose, for stopping leaks in a garden hose, for pulling electrical wires, stopping leaks in a bathroom sink, repairing frayed microphone cables, and weatherproofing the connection between outdoor extension cords and/or holiday lights. In each application, the dispenser 20 allows inexpensive electrical tape to form a secure, weatherproof seal over the object to be sealed.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A dispenser for applying tape from a roll of tape, said dispenser comprising:
a pair of side supports manufactured of a substantially resilient material, wherein said side supports are attached together a substantially fixed distance apart and wherein said side supports each comprise:
an extending arm dimensioned to support an object to be taped in such a way that the object is held in a substantially fixed relationship to a center of the roll of tape as the roll of tape is caused to pivot around the object to be taped: and
an opening therethrough disposed at a location such that an axis defined by a centerpoint of said opening in each side support is substantially perpendicular to each side support;
means for rotatably suspending the roll of tape between said side supports; and
means for applying a variable force upon the roll of tape to resist rotation of the roll of tape such that the tape may be stretched when it is wound about the object.

2. The dispenser as claimed in claim 1 wherein said means for rotatably suspending the roll of tape between said side supports and said means for applying a variable force upon the roll of tape are a single means for both rotatably suspending the roll of tape between said side supports and for applying a variable force upon the roll of tape.

3. The dispenser as claimed in claim 2 wherein said means for both rotatably suspending the roll of tape between said side supports and for applying a variable force upon the roll of tape comprises a friction drag system.

4. The dispenser as claimed in claim 3 wherein said friction drag system comprises;
a substantially hollow shaft dimensioned for insertion within said openings in said side supports;
at least one fastener having a diameter dimensioned for insertion within said hollow shaft; and
a pair of hub spacers, wherein each hub spacer comprises a cylindrical projection dimensioned for insertion within an opening in the roll of tape, a flange portion having an outer surface and an inner surface dimensioned to contact a side of the roll of tape and prevent further insertion of the hub spacers within the opening of the roll of tape when an inward force is applied thereto, and a central opening dimensioned to accept said hollow shaft;
wherein said cylindrical projections of said hub spacers are disposed in opposite sides of the opening in the roll of tape such that said flange portion of each hub spacer contacts the roll of tape, said roll of tape and hub spacers are inserted between said side supports such that said openings in said side supports align with said central openings in said hub spacers, said shaft is inserted through said openings in said side supports and said central openings in said hub spacers, and said at least one fastener is inserted within said hollow shaft, secured, and tightened against said side supports so as to create an inward force upon said side supports.

5. The dispenser as claimed in claim 4 wherein said substantially hollow shaft comprises a plurality of internal threads and wherein said at least one fastener comprises a pair of thumbscrews having external threads dimensioned to mate with said internal threads of said hollow shaft.

6. The dispenser as claimed in claim 4 wherein said side supports each comprises a substantially planar inner surface and wherein said flange portion of each of said hub spacers has a thickness dimensioned to allow said outer surface of said flange portion to be proximate to an inner surface of an adjacent side support when said roll of tape and hub spacers are inserted between said side supports.

7. The dispenser as claimed in claim 4 wherein said flange portion of each of said hub spacers has a diameter that is at least one hundred and fifty percent of a diameter of the opening in the roll of tape.

8. The dispenser as claimed in claim 4 further comprising a compressible member attached to and extending from said outer surface of each of said hub spacers.

9. The dispenser as claimed in claim 8 wherein said compressible member is an O-ring.

10. The dispenser as claimed in claim 4 further comprising a compressible member attached to and extending from said inner surface of each of said side supports.

11. The dispenser as claimed in claim 10 wherein said compressible member is an O-ring.

12. The dispenser as claimed in claim 3 wherein said friction drag system comprises;
a substantially hollow shaft dimensioned for insertion within said openings in said side supports;
at least one fastener having a diameter dimensioned for insertion within said hollow shaft; and
a hollow compressible hub, wherein said compressible hub is substantially cylindrical in shape and comprises two ends defining a length, an outer surface, and a central opening, wherein a diameter of said outer surface is dimensioned for insertion within an opening in the roll of tape, wherein said length is such that each of said ends of said compressible hub are proximate to said inside surface of said side supports, and wherein and a central opening dimensioned to accept said hollow shaft;
wherein said hollow compressible hub is disposed in the opening in the roll of tape, said roll of tape and compressible hub are inserted between said side supports such that said openings in said side supports align with said central opening in said compressible hub, said shaft is inserted through said openings in said side supports and said central opening in said compressible hub, and said at least one fastener is inserted within said hollow shaft, secured, and tightened against said side supports so as to create an inward force upon said side supports.

13. The dispenser as claimed in claim 1 further comprising a cutting blade attached between said side supports.

14. The dispenser as claimed in claim 1 further comprising means for supporting an object that is insufficiently rigid to resist a tension caused by winding the tape over the object.

15. The dispenser as claimed in claim 14 wherein said means for supporting an object that is insufficiently rigid to resist a tension caused by unwinding the tape over the object comprises at least one free spinning roller secured between said side supports.

16. The dispenser as claimed in claim 15 wherein said at least one free spinning roller comprises two free spinning rollers.

17. The dispenser as claimed in claim 16 wherein each roller has a substantially equal diameter and wherein one of said rollers are disposed proximate to the other of said rollers.

18. A dispensing system comprising:
at least two dispensers for applying tape from a roll of tape, each of said dispensers comprising:
a pair of side supports manufactured of a substantially resilient material, wherein said side supports are attached together a substantially fixed distance apart and wherein said side supports each comprise:
an extending arm dimensioned to support an object to be taped in such a way that the object is held in a substantially fixed relationship to a center of the roll of tape as the roll of tape is caused to pivot around the object to be taped: and
an opening therethrough disposed at a location such that an axis defined by a centerpoint of said opening in each side support is substantially perpendicular to each side support;
means for rotatably suspending the roll of tape between said side supports; and
means for applying a variable force upon the roll of tape to resist rotation of the roll of tape such that the tape may be stretched when it is wound about the object; and
means for attaching said at least two dispensers together such that tape from at least two rolls of tape may be simultaneously dispensed.

19. The dispensing system as claimed in claim 18 wherein said means for both rotatably suspending the roll of tape between said side supports and for applying a variable force upon the roll of tape of each dispenser comprises a friction drag system comprising a pair of hub spacers, wherein each hub spacer comprises a cylindrical projection dimensioned for insertion within an opening in the roll of tape, a flange portion having an outer surface and an inner surface dimensioned to contact a side of the roll of tape and prevent further insertion of the hub spacers within the opening of the roll of tape when an inward force is applied thereto, and a central opening;
wherein said means for attaching said at least two dispensers together such that tape from at least two rolls of tape may be simultaneously dispensed comprises:
a substantially hollow shaft dimensioned for insertion through said openings in said side supports of each dispenser, said hollow shaft having a length sufficient to extend between an outermost side support of one dispenser and an outermost side support of another of dispenser;
at least one fastener having a diameter dimensioned for insertion within said hollow shaft, said fastener having a length sufficient to extend through an outermost side supports of one dispenser and an outermost side support of another of dispenser;
wherein said cylindrical projections of said hub spacers are disposed in opposite sides of the roll of tape, said roll of tape and hub spacers are inserted between said side supports such that said openings in said side supports align with said central openings in said hub spacers, said shaft is inserted through said openings in each of said side supports and said central openings in said hub spacers, and said at least one fastener is inserted through said hollow shaft, secured, and tightened against the outermost of said side supports so as to create an inward force upon said side supports.

20. A method of dispensing electrical tape from a dispenser comprising a pair of side supports attached together a substantially fixed distance apart and comprising an extending arm dimensioned to support an object to be taped in such a way that the object is held in a substantially fixed relationship to a center of the roll of tape as the roll of tape is caused to pivot around the object to be taped, and an opening therethrough disposed at a location such that an axis defined by a counterpoint of said opening in each side support is substantially perpendicular to each side support; friction drag system comprises; a substantially hollow shaft dimensioned for insertion within said openings in said side supports; at least one fastener having a diameter dimensioned for insertion within said hollow shaft; and a pair of hub spacers, wherein each hub spacer comprises a cylindrical projection dimensioned for insertion within an opening in the roll of tape, a flange portion having an outer surface and an inner surface dimensioned to contact a side of the roll of tape and prevent further insertion of the hub spacers within the opening of the roll of tape when an inward force is applied thereto, and a central opening dimensioned to accept said hollow shaft; said method comprising the steps of:
disposing said cylindrical projections in opposite sides of the opening in the roll of tape such that said flange portion of each hub spacer contacts the roll of tape;
inserting said roll of tape and hub spacers between said side supports such that said openings in said side supports align with said central openings in said hub spacers;
inserting said shaft through said openings in said side supports and said central openings in said hub spacers;
inserting said at least one fastener within said hollow shaft;
securing said fastener within said hollow shaft;
tightening said fastener against said side supports so as to create an inward force upon said side supports that resists a rotation of the roll of tape within said side supports;
supporting an object to be taped upon said extending arm;
stretching said tape from said roll of tape;
attaching said tape to said object;
rotating said dispenser about said object until said object is sufficiently covered; and
cutting said tape.
